(19) United States
(12) Patent Application Publication
(10) Pub. No.: US 2020/0133293 A1
(43) Pub. Date: Apr. 30, 2020

(54) METHOD AND APPARATUS FOR VIEWING UNDERNEATH A VEHICLE AND A TRAILER

(71) Applicant: GM GLOBAL TECHNOLOGY OPERATIONS LLC, Detroit, MI (US)

(72) Inventors: FARIA CHOWDHURY, STERLING HEIGHTS, MI (US); MOHANNAD MURAD, TROY, MI (US); MICHAEL T. CHANEY, JR., ROYAL OAK, MI (US)

(73) Assignee: GM GLOBAL TECHNOLOGY OPERATIONS LLC, Detroit, MI (US)

(21) Appl. No.: 16/171,869

(22) Filed: Oct. 26, 2018

(51) Int. Cl. G05D 1/02; B60W 40/06; B60W 10/22

(52) U.S. Cl. CPC G05D 1/0246; B60R 1/002; B60W 10/22; B60W 40/06

(57) ABSTRACT

A system and method are provided for aiding an operator in operating a vehicle. In one embodiment, a system includes a sensor system configured to generate sensor data sensed from an environment of the vehicle. The system further includes a control module configured to, by a processor, to determine a scene of the environment based on the sensor data, determine a terrain feature in the environment based on the sensor data, alter a graphic of a vehicle component based on the terrain feature, and generate display data to display the altered graphic and the terrain feature in the scene for viewing by the operator of the vehicle.

### TECHNICAL FIELD

This technical field generally relates to operator aid systems for vehicles, and more particularly, relates to methods and systems for providing a virtual image of under vehicle components in response to road surfaces.

### BACKGROUND

Vehicles may incorporate and utilize numerous aids to assist the operator. For example, various sensors may be disposed at various locations outside. The various sensors sense observable conditions of the environment of the vehicle. For example, a plurality of cameras or other sensors may sense a condition of the road that the vehicle is traveling or about to travel.

Accordingly, it is desirable to provide methods and systems to determine a response of vehicle components such as tires or suspension systems to features of the road surface and to present a virtual image of the predicted response to the driver. It is further desirable to provide methods and system to determine a response of the vehicle components to other sensed information and present a virtual image of the predicted response to the driver. Other desirable features and characteristics of the herein described embodiments will become apparent from the subsequent detailed description and the appended claims, taken in conjunction with the accompanying drawings and the foregoing technical field and background.

### SUMMARY

In one exemplary embodiment, a system to and method are provided for aiding an operator in operating a vehicle. In one embodiment, a system includes a sensor system configured to generate sensor data sensed from an environment of the vehicle. The system further includes a control module configured to, by a processor, to determine a scene of the environment based on the sensor data, determine a terrain feature in the environment based on the sensor data, alter a graphic of a vehicle component based on the terrain feature, and generate display data to display the altered graphic and the terrain feature in the scene for viewing by the operator of the vehicle.

In various embodiments, the control module is further configured to, by the processor, determine at least one of a height, a width, and a depth of the terrain feature, and wherein the control module alters a position of the graphic based on the at least one of the height, the width, and the depth.

In various embodiments, the control module is further configured to, by the processor, determine an actual position of the vehicle component and alter the graphic of the vehicle component based on the actual position.

In various embodiments, the control module is further configured to, by the processor, generate display data to fade at least one of the scene and the altered graphic after the vehicle has stopped moving.

In various embodiments, the control module is further configured to fade the at least one of the scene and the altered graphic based on a first in first out method.

In various embodiments, the terrain feature includes at least one of a rock, a hole, debris, and a curb.

In various embodiments, the vehicle component is at least one of a tire and a suspension system.

In various embodiments, the control module is further configured to, by the processor, receive user input data indicating a viewing angle and select the graphic based on the viewing angle.

In various embodiments, the display data displays the scene and the altered graphic according to a virtual reality.

In various embodiments, the sensor system includes a plurality of at least one of lidars, radars, ultrasounds, and cameras disposed about the vehicle.

In various embodiments, a method includes: receiving sensor data from a sensor system that senses an environment of the vehicle; determining, by a processor, a scene of the environment based on the sensor data; determining, by the processor, a terrain feature in the environment based on the sensor data; altering, by the processor, a graphic of a vehicle component based on the terrain feature; and generating display data to display the altered graphic and the terrain feature in the scene for viewing by the operator of the vehicle.

In various embodiments, the method includes determining at least one of a height, a width, and a depth of the terrain feature, and wherein the altering is based on the at least one of the height, the width, and the depth.

In various embodiments, the method includes determining an actual position of the vehicle component and wherein the altering the graphic of the vehicle component is further based on the actual position.

In various embodiments, the method includes generating display data to fade at least one of the scene and the altered graphic after the vehicle has stopped moving.

In various embodiments, the fading the at least one of the scene and the altered graphic is based on a first in first out method.

In various embodiments, the terrain feature includes at least one of a rock, a hole, debris, and a curb.

In various embodiments, the vehicle component is at least one of a tire and a suspension system.

In various embodiments, the method includes receiving user input data indicating a viewing angle and selecting the graphic based on the viewing angle.

In various embodiments, the display data displays the scene and the altered graphic according to a virtual reality.

In various embodiments, the sensor system includes a plurality of at least one of lidars, radars, ultrasounds, and cameras disposed about the vehicle.

### DESCRIPTION OF THE DRAWINGS

The exemplary embodiments will hereinafter be described in conjunction with the following drawing figures, wherein like numerals denote like elements, and wherein:

FIG. 1 is an illustration of a top perspective schematic view of a vehicle having a virtual reality system in accordance with various embodiments;

FIG. 2 is a functional block diagram illustrating a virtual reality system in accordance with various embodiments;

FIG. 3 is an illustration of a display of the virtual reality system in accordance with various embodiments;

FIG. 4 is a dataflow diagram illustrating the control module of the virtual reality system in accordance with various embodiments; and

FIG. 5 is a flowchart illustrating a method of controlling content to be displayed on a display screen of the virtual reality system in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term system or module may refer to any combination or collection of mechanical and electrical hardware, software, firmware, electronic control component, processing logic, and/or processor device, individually or in any combination, including without limitation: application specific integrated circuit (ASIC), an electronic circuit, a processor (shared, dedicated, or group), memory that contains one or more executable software or firmware programs and associated data, a combinational logic circuit, and/or other suitable components that provide the described functionality.

Embodiments may be described herein in terms of functional and/or logical block components and various processing steps. It should be appreciated that such block components may be realized by any number, combination or collection of mechanical and electrical hardware, software, and/or firmware components configured to perform the specified functions. For example, an embodiment of the invention may employ various combinations of mechanical components, e.g., towing apparatus, indicators or telltales; and electrical components, e.g., integrated circuit components, memory elements, digital signal processing elements, logic elements, look-up tables, imaging systems and devices or the like, which may carry out a variety of functions under the control of one or more microprocessors or other control devices. In addition, those skilled in the art will appreciate that the herein described embodiments may be practiced in conjunction with any number of mechanical and/or electronic systems, and that the vehicle systems described herein are merely exemplary.

For the sake of brevity, conventional components and techniques and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention.

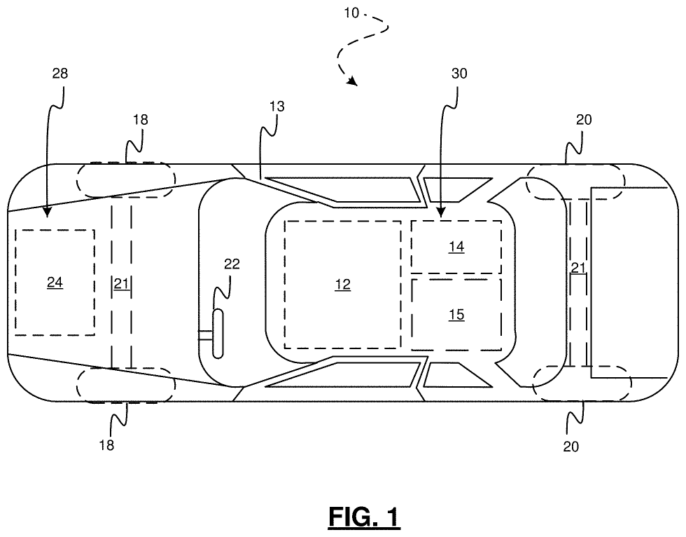

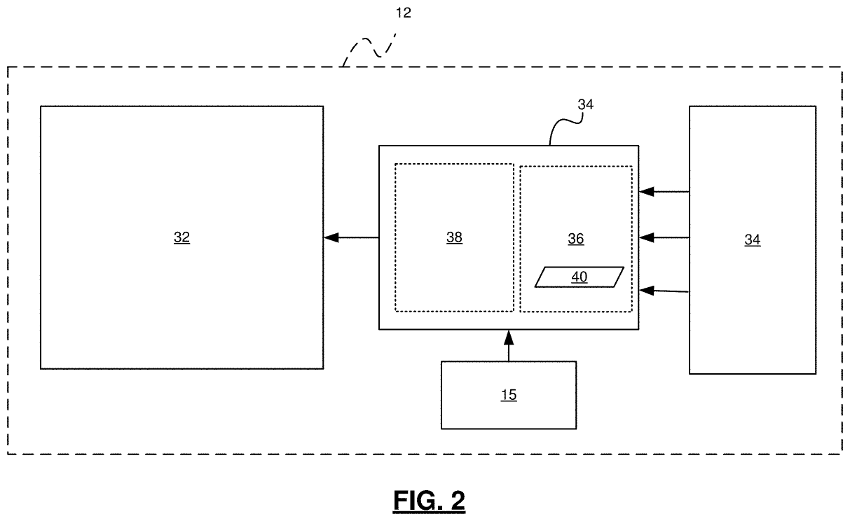

FIG. 1 is an illustration of a top view of a vehicle shown generally at 10 equipped with a virtual reality system shown generally at 12 in accordance with various embodiments. As will be discussed in more detail below, the virtual reality system 12 generally uses data from a sensor system 14 of the vehicle 10 along with customizable software to allow a user to experience a virtual reality of a feature underneath the vehicle 10. As used herein, the term “virtual reality” refers to a replication of an environment and/or component, real or imagined. For example, the virtual reality system 12 can be implemented to provide a visualization of features underneath the vehicle 10. In such examples, a display screen 16 (FIG. 2) can be placed in any location of the vehicle 10 and can display images and/or videos that create a virtual reality of the underneath of the vehicle 10, for example, as if the vehicle hood or the vehicle under carriage were invisible.

Although the context of the discussion herein is with respect to the vehicle 10 a passenger car, it should be understood that the teachings herein are compatible with all types of automobiles including, but not limited to, sedans, coupes, sport utility vehicles, pickup trucks, minivans, full-size vans, trucks, and buses as well as any type of towed vehicle such as a trailer.

As shown in the example of FIG. 1, the vehicle 10 generally includes a body 13, front wheels 18, rear wheels 20, a suspension system 21, a steering system 22, and a propulsion system 24. The wheels 18-20 are each rotationally coupled to the vehicle 10 near a respective corner of the body 13. The wheels 18-20 are coupled to the body 13 via the suspension system 21. The wheels 18 and/or 20 are driven by the propulsion system 24. The wheels 18 are steerable by the steering system 22.

The body 13 is arranged on or integrated with a chassis (not shown) and substantially encloses the components of the vehicle 10. The body 13 is configured to separate a powertrain compartment 28 (that includes at least the propulsion system 24) from a passenger compartment 30 that includes, among other features, seating (not shown) for one or more occupants of the vehicle 10. As used herein, the components “underneath” the vehicle 10 are components disposed below the body 13, such as, but not limited to, the wheels 18 and 20 (including their respective tires), and the suspension system 21.

The vehicle 10 further includes a sensor system 14 and an operator selection device 15. The sensor system 14 includes one or more sensing devices that sense observable conditions of components of the vehicle 10 and/or that sense observable conditions of the exterior environment of the vehicle 10. The sensing devices can include, but are not limited to, radars, lidars, global positioning systems, optical cameras, thermal cameras, ultrasonic sensors, height sensors, pressure sensors, steering angle sensors, and/or other sensors. The operator selection device 15 includes one or more user manipulable devices that can be manipulated by a user in order to provide input. The input can relate to, for example, activation of the display of virtual reality content and a desired viewing angle of the content to be displayed. The operator selection device 15 can include a knob, a switch, a touch screen, a voice recognition module, etc.

As shown in more detail in FIG. 2 and with continued reference to FIG. 1, the virtual reality system 12 includes a display screen 32 communicatively coupled to a control module 34. The control module 34 is communicatively coupled to the sensor system 14 and the operator selection device 15.

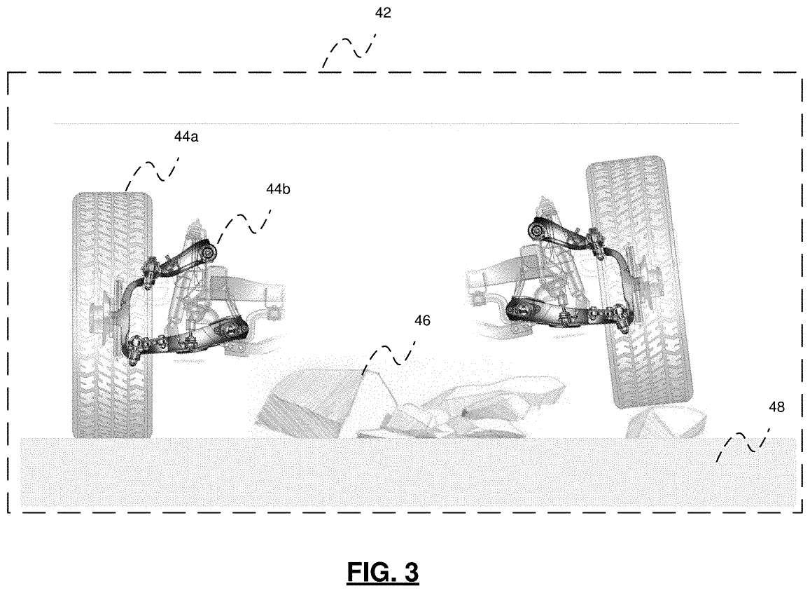

The display screen 32 may be disposed within the passenger compartment 30 at a location that enables viewing by an operator of the vehicle 10. For example, the display screen 32 may integrated with an infotainment system (not shown) or instrument panel (not shown) of the vehicle 10. The display screen 32 displays content such that a virtual reality is experienced by the viewer. For example, as shown in FIG. 3, in various embodiments, the content 42 includes graphics of vehicle components 44a-44b, graphics of terrain features 46, and a depiction of a scene 48 the vehicle 10 is traveling, including the ground, curbs, road markings, buildings, etc.

The virtual reality content 42 can be displayed in realtime and/or can be predefined. For example, as shown in FIG. 3, a virtual image of the front tires is created through the vehicle hood by creating a virtual overlay revealing the terrain. The virtual reality content 42 is displayed to allow the operator to see through and underneath their vehicle at different viewing angles. Augmented tire and suspension graphics are adjusted to simulate how graphics of tires adjust when the vehicle 10 is rolled over objects such as small rocks for the different viewing angles.

With reference back to FIG. 1, the control module 34 may be dedicated to the display screen 32, may control the display screen 32 and other features of the vehicle 10 (e.g., a body control module, an instrument control module, or other feature control module), and/or may be implemented as a combination of control modules that control the display screen 32 and other features of the vehicle 10. For exemplary purposes, the control module 34 will be discussed and illustrated as a single control module that is dedicated to the display screen 32. The control module 34 controls the display screen 32 directly and/or communicates data to the display screen 32 such that virtual reality content can be displayed.

The control module 34 includes at least memory 36 and a processor 38. As will be discussed in more detail below, the control module 34 includes instructions that when processed by the processor 38 control the content to be displayed on the display screen 32 based on sensor data received from the sensor system 14 and user input received from the operator selection device 15. The control module further includes instructions that when processed by the processor 38 control the content to be displayed based on graphics 40 illustrating components underneath the vehicle 10. The graphics 40 may be predefined and stored in the memory 36.

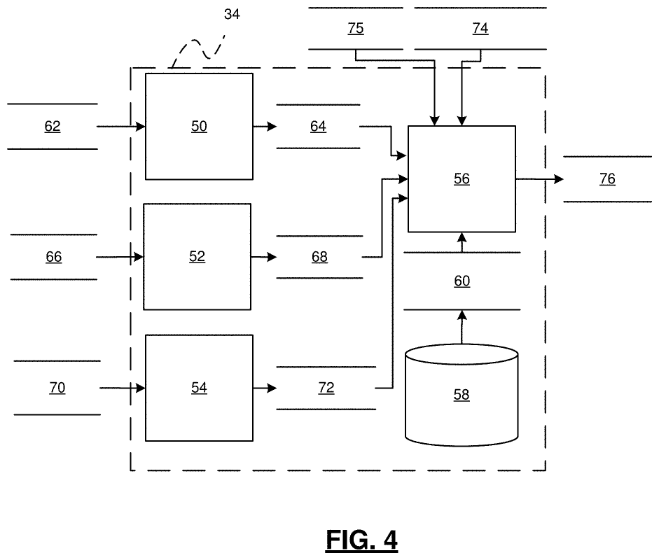

Referring now to FIG. 4 and with continued reference to FIG. 1-3, a dataflow diagram illustrates various embodiments of the control module 34 in greater detail. Various embodiments of the control module 34 according to the present disclosure may include any number of sub-modules. As can be appreciated, the sub-modules shown in FIG. 4 may be combined and/or further partitioned to similarly generate virtual reality content to be viewed by an operator. Inputs to the control module 34 may be received from the sensor system 14, received from the operator selection device 15, received from other control modules (not shown) of the vehicle 10, and/or determined by other sub-modules (not shown) of the control module 34. In various embodiments, the control module 34 includes a scene determination module 50, a terrain feature determination module 52, a vehicle component determination module 54, a display determination module 56, and a graphics datastore 58.

The graphics datastore 58 receives and stores graphics 60 for various features of the vehicle 10 such as features underneath the vehicle 10 including the front tires 18, the rear tires 20, the suspension system components, etc. as shown, for example, in FIG. 3. In various embodiments, the graphics 60 for each vehicle feature are depicted for a number of different viewing angles and the graphics datastore 58 stores the graphics 60 based on the associated viewing angle.

The scene determination module 50 receives as input sensor data 62. The scene determination module 50 captures one or more scenes of the environment based on the sensor data 62. For example, the sensor data 62 can include image data or video data provided by a plurality of cameras disposed about the vehicle 10, and the scene determination module 50 captures a scene (e.g., 360-degree view of the environment) based on the image or video data. The scene determination module 50 generates scene data 64 based on the determined scene.

The terrain feature determination module 52 receives as input sensor data 66. The terrain feature determination module 52 processes the sensor data 66 to construct an understanding of terrain features along the ground. The sensor data 66 can include lidar data, radar data, image data, ultrasound data, etc. The understanding can include, but is not limited to, a location, a height, a width, a depth, etc. of. holes, rocks, curbs, debris, etc. along the ground surface at 330. The terrain feature determination module 52 generates terrain data 68 based on the determined understanding.

The vehicle component determination module 54 receives as input sensor data 70. The vehicle component determination module 54 processes the sensor data 70 to determine an actual position of the various vehicle features. For example, the sensor data 70 can include height data, pressure data, etc. from the body 13 and/or suspension system 21. The vehicle component determination module 54 generates vehicle data 72 based on the actual position of the vehicle features.

The display determination module 56 receives as input the scene data 64, the terrain data 68, the vehicle data 72, current location data 75, and user input data 74. Based on the received data, the display determination module 56 generates display data 76 to display the content 42 including the scene and the vehicle features as a virtual reality to an operator.

For example, as the vehicle 10 travels, the display determination module 56 embeds graphics 60 retrieved from the graphics datastore 58 illustrating the terrain features in the scene based on the location of the terrain feature and the current location of the current location data 75. The display determination module 56 retrieves the graphics 60 of the vehicle features from the graphics datastore 58 based on the selected viewing angle indicated by the user input data 74 and alters the positioning of the graphics 60 (e.g., rotates, lifts, etc.) based on the height, width, depth, etc. of the terrain feature. In addition, or as an alternative, the display determination module 56 alters the positioning of the graphics 60 (e.g., rotates, lifts, etc.) based on vehicle data 72 including the actual positions of the vehicle features. The display determination module 56 then overlays the altered vehicle feature graphics on the scene indicated by the scene data 74 at a location relative to the terrain feature. The display determination module 56 then generates the display data 76 that includes the scene, the altered vehicle component graphics, and the terrain features.

Once the vehicle 10 stops traveling, and optionally after a short period of time, the display determination module 56 generates display data 76 that causes the scene to fade (including or not including the graphics) and return to a default scene (e.g., black or dashed lines). This can be done, for example, using a first in first out (FIFO) concept where the oldest information fades out first.

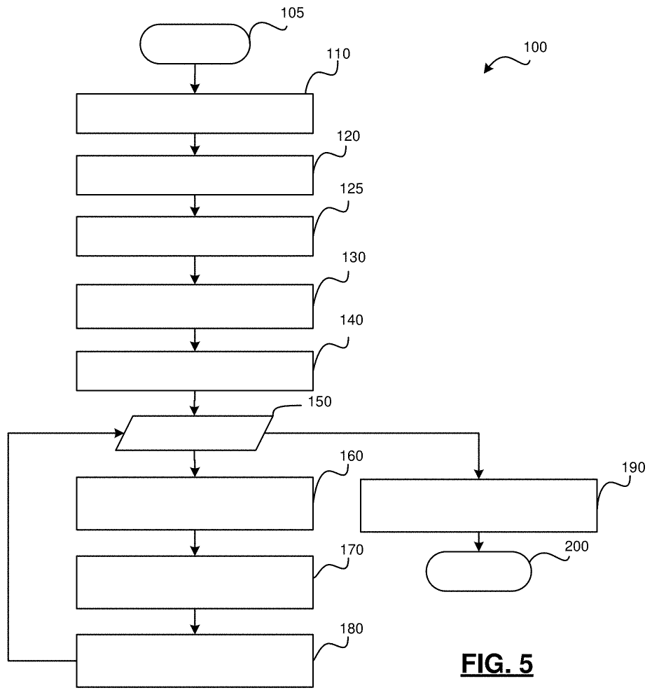

Referring now to FIG. 5, and with continued reference to FIGS. 1-4 a flowchart illustrates a method 100 that can be performed by the virtual reality system 12 in accordance with various embodiments. As can be appreciated in light of the disclosure, the order of operation within the method 100 is not limited to the sequential execution as illustrated in FIG. 5 but may be performed in one or more varying orders as applicable and in accordance with the present disclosure.

As can further be appreciated, the method of FIG. 5 may be scheduled to run at predetermined time intervals during operation of the vehicle 10 and/or may be scheduled to run based on predetermined events.

In one example, as shown in FIG. 5, the method 100 may begin at 105. The graphics 60 of the various vehicle features are stored for various viewing angles at 110. Thereafter, sensor data 62, 66, 70 is received at 120. User input data 74 indicating a viewing angle is received at 125. A scene of the environment including the ground surface is captured from the sensor data 62 at 130. The sensor data 66 is processed to construct an understanding (e.g., location, height, depth, depression, etc.) of terrain features such as, but not limited to, holes, rocks, curbs, debris, etc. along the road at 140.

As the vehicle travels along the road at 150, graphics 60 illustrating the terrain features according to the selected viewing angle are selected, and the graphics 60 are altered based on the understanding of the terrain feature at 160. The altered graphics are then overlaid on the scene at a location relative to the terrain feature at 170. Additionally or alternatively, the sensor data 70 from the chassis and/or suspension system is processed in order to determine actual positions of the vehicle features and the graphics 60 of the vehicle features are altered based on the actual position and overlaid at 170. The display data 76 is generated based on the scene and the overlaid data at 180.

Once the vehicle stops traveling at 150, and optionally after a short period of time, the scene is faded at 190 (including or not including the graphics) and returns to a default scene (e.g., black or dashed lines). This can be done, for example, using a first in first out (FIFO) concept where the oldest information fades out first. Thereafter, the method may end at 200.

As can be appreciated, the method 100 may continue to run so long as the vehicle 10 is moving, the aid feature is enabled, or the vehicle 10 is attempting a maneuver such as, but not limited to, backing, parking off a road, or crawl mode type of driving.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. A system to aid an operator in operating a vehicle, comprising:
a sensor system configured to generate sensor data sensed from an environment of the vehicle; and
a control module configured to, by a processor, to determine a scene of the environment based on the sensor data, determine a terrain feature in the environment based on the sensor data, alter a graphic of a vehicle component based on the terrain feature, and generate display data to display the altered graphic and the terrain feature in the scene for viewing by the operator of the vehicle.

2. The system of claim 1, wherein the control module is further configured to, by the processor, determine at least one of a height, a width, and a depth of the terrain feature, and wherein the control module alters a position of the graphic based on the at least one of the height, the width, and the depth.

3. The system of claim 1, wherein the control module is further configured to, by the processor, determine an actual position of the vehicle component and alter the graphic of the vehicle component based on the actual position.

4. The system of claim 1, wherein the control module is further configured to, by the processor, generate display data to fade at least one of the scene and the altered graphic after the vehicle has stopped moving.

5. The system of claim 4, wherein the control module is further configured to fade the at least one of the scene and the altered graphic based on a first in first out method.

6. The system of claim 1, wherein the terrain feature includes at least one of a rock, a hole, debris, and a curb.

7. The system of claim 1, wherein the vehicle component is at least one of a tire and a suspension system.

8. The system of claim 1, wherein the control module is further configured to, by the processor, receive user input data indicating a viewing angle and select the graphic based on the viewing angle.

9. The system of claim 1, wherein the display data displays the scene and the altered graphic according to a virtual reality.

10. The system of claim 1, wherein the sensor system includes a plurality of at least one of lidars, radars, ultrasounds, and cameras disposed about the vehicle.

11. A method for aiding an operator in operating a vehicle, comprising:
receiving sensor data from a sensor system that senses an environment of the vehicle;
determining, by a processor, a scene of the environment based on the sensor data;
determining, by the processor, a terrain feature in the environment based on the sensor data;
altering, by the processor, a graphic of a vehicle component based on the terrain feature; and
generating display data to display the altered graphic and the terrain feature in the scene for viewing by the operator of the vehicle.

12. The method of claim 11, further comprising determining at least one of a height, a width, and a depth of the terrain feature, and wherein the altering is based on the at least one of the height, the width, and the depth.

13. The method of claim 11, further comprising determining an actual position of the vehicle component and wherein the altering the graphic of the vehicle component is further based on the actual position.

14. The method of claim 11, further comprising generating display data to fade at least one of the scene and the altered graphic after the vehicle has stopped moving.

15. The method of claim 14, wherein the fading the at least one of the scene and the altered graphic is based on a first in first out method.

16. The method of claim 11, wherein the terrain feature includes at least one of a rock, a hole, debris, and a curb.

17. The method of claim 11, wherein the vehicle component is at least one of a tire and a suspension system.

18. The method of claim 11, further comprising receiving user input data indicating a viewing angle and selecting the graphic based on the viewing angle.

19. The method of claim 11, wherein the display data displays the scene and the altered graphic according to a virtual reality.

20. The method of claim 11, wherein the sensor system includes a plurality of at least one of lidars, radars, ultrasounds, and cameras disposed about the vehicle.
